(19) United States
(12) Patent Application Publication
(10) Pub. No.: US 2004/0120553 A1
(43) Pub. Date: Jun. 24, 2004

(54) Device for contactless optical acquisition of biometric characteristics of at least one body part

(76) Inventor: Anatoli Stobbe, Barsinghausen (DE)

Correspondence Address: WILLIAM COLLARD, COLLARD & ROE, P.C., 1077 NORTHERN BOULEVARD, ROSLYN, NY, 11576, US

(21) Appl. No.: 10/678,673

(22) Filed: Oct. 3, 2003

(30) Foreign Application Priority Data
Oct. 5, 2002 (DE) 102 46 411.1

(51) Int. Cl. G06K 9/00

(52) U.S. Cl. 382/115

(57) ABSTRACT

A device for contactless optical acquisition of biometric characteristics of at least one body part with at least one camera having a lens system and an image sensor. The device acquires a surface image of body part which is positionable in an object plane. The lens system provides distortion-free imaging in the entire image field and has a depth of field which at least corresponds to the maximum topographic extension of the surface contour of the surface of the body part, which surface is acquirable from one direction by the camera. The device has a positioning assistance device which generates directions to a user in order to provide contactless positioning of the surface of the body part to be imaged in the object plane.

### CROSS REFERENCE TO RELATED APPLICATIONS

Applicant claims priority under 35 U.S.C. §119 of German Application No. 102 46 411.1 filed Oct. 5, 2002.

### BACKGROUND OF THE INVENTION

1. Field of the Invention

The present invention relates to a device having at least one camera including a lens system and an image sensor for contactless optical acquisition of biometric characteristics of at least one body part by taking a surface image of the body part which is positioned in one object plane.

2. The Prior Art

In order to furnish proof that persons are authorized to gain access to secure objects such as buildings, rooms, safes, automatic teller machines or computers, apart from authorization cards with automatically readable codes as well as with manual input of codes, it is also possible to evaluate biometric data of the persons who are authorized to gain access. Compared to other types of proof, biometric data have the advantage that they are individually linked to the authorized person and are not susceptible to misappropriation by third parties, as authorization cards are, or snooping, as manually entered codes are.

A system for contactless recognition of hand lines and finger lines is known from EP 1 073 988 B1. By means of a camera, the hand lines and finger lines of a person are optically acquired and electronically evaluated. Several different solutions are disclosed in order to ensure that the area to be imaged by the camera is located in the object plane of the camera so that it will be in focus on the image plane of the camera.

In one embodiment, a hand or finger rests against a support. According to another embodiment, a template with an opening in the shape of a contour of a hand is provided, and a hand is placed into the opening. A further embodiment provides for the projection of two photographs onto a hand. The two photographs are converged by moving the position of the hand accordingly. In another embodiment, an aerial image of a hand is generated by means of a hologram, which specifies the position of the hand of a person to be identified. The solutions for contactless positioning relate to the hand as a whole, not separately to the palm of the hand to be imaged.

### SUMMARY OF THE INVENTION

It is an object of the present invention to create a device of the type mentioned in the introduction which makes possible improved resolution and contactless optical acquisition of biometric characteristics of at least one body part by means of a camera and provides better and safer evaluation and differentiation.

These and other objects are achieved by a device for contactless optical acquisition of biometric characteristics of at least one body part by taking a surface image of the body part which is positionable in one plane in accordance with the invention. The device has at least one camera including a lens system and an image sensor. The lens system provides distortion-free imaging in the entire image field and has a depth of field which at least corresponds to the maximum topographic extension of the surface contour of the surface of the body part, which surface is acquired from one direction by the camera. The device also includes a positioning assistance device by means of which assistance device directions to a user can be generated with a view to contactless positioning of the surface of the body part to be imaged in the object plane.

Improvements and advantageous embodiments are also described below.

The use of a lens system which provides distortion-free imaging in the entire image field results in true to scale reproduction of biometric characteristics of a body part on the focal plane of the camera, so that independently of the position of the body part in the object plane, the characteristics are imaged so as to be the same. The imaging scale is thus exactly the same at the image margin as it is in the center of the image. It is thus not necessary to provide distortion rectification, as would be necessary, for example, in the case of a wide-angle lens system or a fisheye lens system. In this way, the algorithms which are applied during evaluation can be kept simpler. This reduces the computing time required for evaluation and thus also the delay time between commencement of imaging the biometric characteristics and the result of the evaluation.

A further characteristic, namely that the depth of field corresponds at least to the maximum topographic surface contour of the surface of the body part, which surface is acquired from one direction by the camera, makes possible an in-focus superficial image of the body part despite it being three-dimensional. In this way, not only are the biometric characteristics of the region of the body part which is situated exactly in the object plane of the lens system imaged in sharp focus, but the biometric characteristics of those regions which are closer to, or further from, the lens system in relation to the exact object plane are imaged in sharp focus as well. Even unavoidable tolerances during free (i.e. non-supported) positioning of the body part in space do not result in any undesirable reduction in the sharpness of the image.

A positioning assistance device provides the user with instructions to position the surface of the body part to be imaged in the object plane. Contrary to the solution discussed in the prior art, in this way the body part is not simply aligned as an entity, i.e. irrespective of its three-dimensionality, but instead, the surface to be imaged is positioned in the object plane as precisely as possible.

This provides the advantage that the depth of field of the lens system of the camera need only account for unavoidable tolerances during free positioning in space and the maximum topographic surface profile. Consequently, larger focal apertures or shorter exposure times than would be possible with a design in which the depth of field must take into account all imaginable deviations from the object plane can be achieved.

In another embodiment, the depth of field of the lens system additionally includes a region which corresponds to inaccuracies in the position of the surface of the body part to be imaged. Inaccuracies can result from deviations in distance in relation to an ideal position caused by rotation or inclination.

In this way, tolerances which are caused by individual positioning of the body part are taken into account. These tolerances cannot be avoided by instructions issued to the user, or can be avoided only with great difficulty.

Preferably, the ratio of object width to focal length is greater than 10. With this dimension rule and a specified focal length, an object width can be stated at which an adequate depth of field is achieved, taking into account the above-mentioned tolerance range.

Several deviation mirrors can be arranged in a beam path between the object plane and the lens system. This makes it possible to keep the design compact even in the case of large object widths.

The biometric characteristics of a body part or of the body parts can be acquired from one side or from several sides. In this way, larger regions or additional spatial characteristics can be acquired, and recognition security can be improved. Furthermore, in this way, several body parts can be acquired in one process. Hands or fingers are suitable body parts. They can be acquired from the inside, i.e. with hand lines or finger lines, from above, from the front, or from the side.

Acquisition of the body parts from several sides can be carried out by means of at least one camera, with evaluation of the images taking place individually or in combination. In this way, the biometric characteristics can be evaluated individually from different angles of view, or alternatively an overall evaluation can be carried out by superposition.

The positioning assistance device can include a light source which emanates a directed light beam in a visible spectrum for centering. This makes it easier for a user to position a body part in an object plane such that maximum coverage and acquisition of all relevant biometric characteristics are possible.

Furthermore, the positioning assistance device can include a sensor for determining an actual object plane of a body part, and an output device for providing instructions to find a desired object plane.

The positioning assistance device makes it possible for a user, by following directions, to re-position a body part such that the surface to be imaged comes to be positioned as accurately as possible in the object plane. This allows optimum imaging of the biometric characteristics on the focal plane of the camera, and makes a correspondingly accurate evaluation possible.

In an advantageous embodiment, the sensor includes a photoelectric barrier array. In this way, with simple means, the position of the object plane of the body part can be acquired in stages, independently of its spatial dimensions, and signals for correction can be generated.

Preferably, the photoelectric barrier array emits light in an invisible spectrum. In this way a user is not bothered by additional light sources apart from the light source provided by a directed light beam for centering.

Alternatively, the sensor can include a distance sensor operating on a capacitive, high-frequency or ultrasound basis.

Preferably the output device comprises optical or acoustic display device. In this way, correction instructions which are generally understandable can be given, and can react directly to corresponding corrective movements of the user.

According to another embodiment, a camera can acquire several shots of the same surface image. Subsequently, if the quality of the shots varies, the best shot or the best shots from a series of shots can be evaluated. Accordingly, if individual shots are of inadequate quality, the user does not need to repeat the acquisition procedure.

Furthermore, by means of a camera, several shots of the same surface image at different exposures can be acquired and evaluated together. With this measure, limitations of the camera's contrast resolution are overcome in that with different exposures, an overall contrast is achieved in each image area which makes it possible to evaluate the biometric characteristics.

The device can include a light source for illuminating a surface of a body part to be acquired, with the light source including a light emitting diode arrangement or at least one flash tube.

In this way, at a small design size, even illumination of a body part or parts to be acquired is provided so that optimum contrast is achieved.

Furthermore, exposure can be controlled or regulated over an entire duration during which a light emitting diode arrangement or the flash tube lights up. In this way, exposure can be adapted to different reflection behavior and absorption behavior of a body part or parts to'be acquired. Such different behavior may be due, for example, to different tanning of the skin or due to race-specific characteristics.

Preferably, the positioning assistance device light source can be switched off during exposure. In this way, when a shot of the surface area of the body parts to be acquired is taken, falsification by other light sources can be avoided.

The light source for illuminating the surfaces of a body part to be acquired can emit white light or monochrome light of one or several light wavelengths selected from a visible and/or invisible spectrum. If the light wavelengths of the light source are different, several shots of the same surface image can be acquired.

By alternatively using white light and monochrome light of one or several selectable light wavelengths, biometric characteristics which are more pronounced at certain light wavelengths can be recognized more effectively. Furthermore, optimization for different skin types of the body parts, or optimization of race-specific differences can be achieved.

The device can include an evaluation device for acquired surface images of body parts which determines biometric characteristics mathematically by applying computation algorithms. The same computation algorithms can be applied to different surface images of the same body part or different computation algorithms can be applied to the same surface images. In this way, evaluation accuracy is improved, and individual adaptation of the evaluation options can be carried out for biometric characteristics of persons, which can be different in humans of different skin color or race.

Furthermore, during acquisition of the surface image of a body part for the first time and application of computing algorithms, those computation algorithms which return the best results can be stored in a memory. In a subsequent acquisition of a surface image, the stored computation algorithms can be preferentially applied. In this way, optimum results can be achieved in a targeted way, and time-intensive incorrect calculations can be avoided.

The device can include additional light sources and sensors to determine the light transmitting capacity and/or the reflection characteristics of a body part as additional biological characteristics. These characteristics can then supplement the biometric characteristics of the surface and in this way render the evaluation more reliable.

Furthermore, the additional light sources can emit pulsed light or light of changing intensity, and by means of the evaluation device, the signals of the sensors, which are triggered by pulsed light or light of changing intensity, can be evaluated.

Pulsed light or light of changing intensity results in better separation to guard against the influence of extraneous light. Furthermore, it is also possible to acquire frequency-dependent light-transmitting and light-reflecting characteristics of the body parts as additional characteristics. Finally, the application of pulsed light or light of changing intensity makes possible a higher peak light amplitude with comparatively lower average output. In the case of laser light, this reduces the danger of damaging the body parts as a result of excessive irradiation output, and of damaging the eyes as a result of scattered light emanating from the device.

According to another embodiment, the biometric characteristics obtained by evaluating an acquired surface image of a body part and the additional biometric characteristics can be stored together. Such supplementation and such a multitude of the biometric characteristics acquired improves the evaluation accuracy and reliability.

Furthermore, by comparing measured additional biometric characteristics with stored additional biometric characteristics, manipulation detection can be carried out.

If there is only one type of biometric characteristic to be viewed, for example, the surface of body parts, there is a possibility of manipulation, for example by copying the surface characteristics of an authorized person and by transferring these characteristics, for example, in the form of a film, to the surface of the body part of another person who is not authorized. However, if in such a case the additional biometric characteristics such as light transmitting capacity or reflection characteristics are different, then there is not complete agreement with all of the biometric characteristics. This can suggest a manipulation attempt.

A further possibility of manipulation detection consists of uncovering different characteristics by comparing measured biometric characteristics with stored biometric characteristics which are acquired on the basis of surface images of a body part with different illumination colors.

If, for example, films with the graphic pattern of the biometric characteristics of another person are used, due to the differences in the optical characteristics of the extraneous material as compared to the optical characteristics of real skin, deviations in the imaging characteristics can occur. Such deviations can be detected with the use of different illumination colors.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 shows a front view of a device according to the invention; and

FIG. 2 shows a lateral view of the device according to the invention.

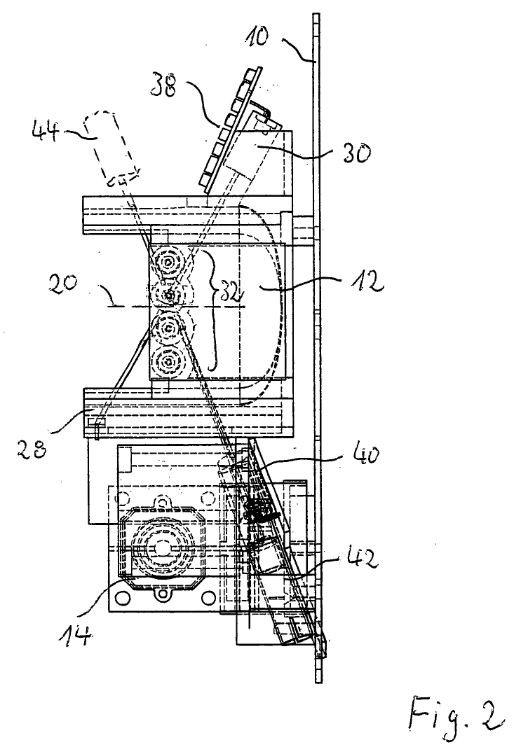

### DETAILED DESCRIPTION OF THE INVENTION

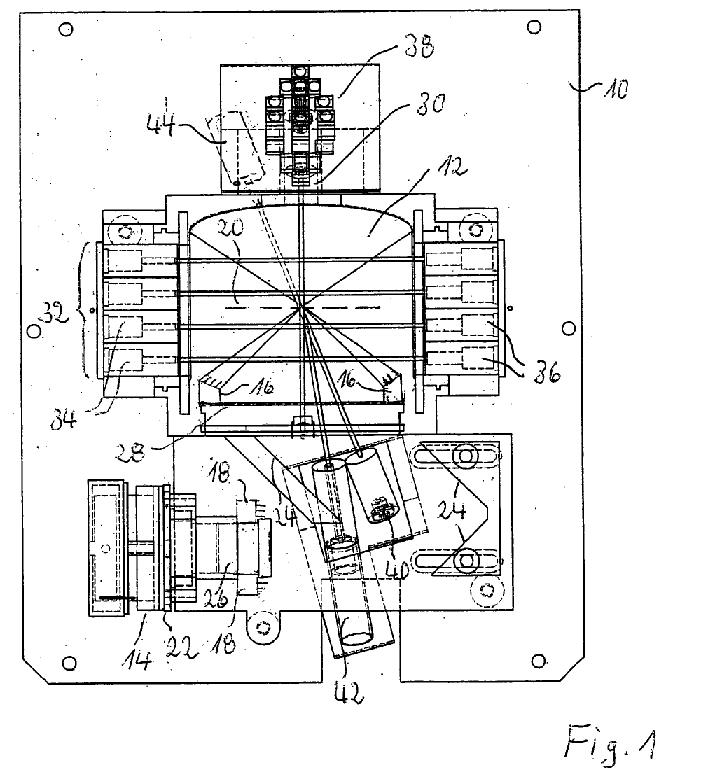

Turning now in detail to the drawings, FIG. 1 shows a device including a housing 10 with an acquisition chamber 12, a camera 14 and an illuminations device 16, 18. A body part to be acquired, for example, one or several fingers or a hand, is/are placed in acquisition chamber 12 and is/are subsequently optically acquired by camera 14.

An object plane 20 for the surface of the body part to be imaged extends approximately horizontally in the middle of acquisition chamber 12. A body part which is located in this object plane 20 is imaged on the image plane of camera 14.

A beam path extends from object plane 20 by way of deviation mirrors 24 to camera 14 which comprises a lens system 26, and, on the focal plane, an image sensor 22, for example, a CCD sensor.

Lens system 26 of camera 14 generates a distortion-free image, for example, all the details in object plane 20 are imaged true to scale on the focal plane. Lens system 26 includes a focal length with the characteristics of a standard lens/telephoto lens, but not with the characteristics of a wide-angle lens, because with a wide-angle lens, distortion-free imaging could not be guaranteed. Good imaging characteristics are achieved in the case of focal lengths of more than 6 millimeters, with a focal length range of between 10 and 15 millimeters being preferable.

The object width, that is, the optical distance between object plane 20 and lens system 26, is at least 10 times the focal length. This results in a depth of field which ensures sharp focus over the entire maximum topographic surface contour of a surface of a three-dimensional body part, which surface is acquirable from one direction.

An illumination device 16, 18 with light sources in the form of light emitting diodes is used for illuminating the surface of the body part to be acquired. In this design, light emitting diodes 16 are arranged on the sides of a frame 28 in the lower region of acquisition chamber 12, with additional light emitting diodes 18 being arranged in direct proximity, on the sides of lens system 26 of camera 14. Light emitting diodes 16 which are arranged on the sides of frame 28 laterally illuminate the body part at a large angle of aperture, while light emitting diodes 18, which are arranged near camera 14, illuminate the center of the body part at a small angle of aperture by way of deviation mirrors 24. Overall, very even illumination is achieved with this combined arrangement of light emitting diodes 16, 18.

The device also includes a positioning assistance device. The positioning assistance device includes a light source 30 which projects a directed light beam along an imaginary vertical plane in the center of acquisition chamber 12 from top to bottom. This light beam impinges upon a body part in a way which is visible to a user, thus making it easy for a user to position a body part such that the light beam impinges exactly upon its center.

To the side of acquisition chamber 12 there is a sensor, in the form of a photoelectric barrier array 32, for determining an actual object plane of a body part. For this purpose, light emitting diodes 34 are arranged on one side and sensors 36 are arranged on the other side. Together, light emitting diodes 34 and sensors 36 form a light curtain. Sensors 36 are connected to an output device in the form of an optical display device 38 which issues instructions directing a user to raise or lower his/her body part if the surface which faces camera 14 is not positioned in object plane 20.

If the light curtain is interrupted below object plane 20, then display device 38 generates an arrow which points upward. If the light curtain is interrupted above object plane 20, a corresponding arrow which points downward is generated. The correct position is reached if the light curtain is interrupted exactly in the region of object plane 20.

The device also includes an additional light source 40 and an additional sensor 42 below acquisition chamber 12. With additional light source 40 and additional sensor 42, the reflection characteristics of a body part are acquired as additional biometric characteristics. Moreover, an additional sensor 44 may be provided, with which the light transmitting capacity of a body part can be acquired. Instead of using a common light source, it is also possible to use a separate light source as well as a separate sensor in order to evaluate light of different wavelengths. In this case, the images obtained by camera 14 are then evaluated by means of computation algorithms performed by an evaluation device (not shown), as are the additional biometric characteristics of the light transmitting capacity and the reflection characteristics which were acquired by the additional light sources and sensors.

In order to make it possible for the device to carry out identification, the biometric characteristics of a person are first acquired in a way which is manipulation-proof, such as, under supervision, and stored on a code card. During subsequent identification, the acquired biometric characteristics are compared with the characteristics stored on the code card. In this arrangement, among a multitude of possible biometric characteristics, it is possible to individually determine some characteristics which must be checked with priority or given greater weight. It is also possible, as part of this determination, to determine and store as information computation algorithms which provide better results, in relation to the particular person, than would be the case with other computation algorithms.

Accordingly, while a few embodiments of the present invention have been shown and described, it is to be understood that many changes and modifications may be made thereunto without departing from the spirit and scope of the invention as defined in the appended claims.

What is claimed is:

1. A device for contactless optical acquisition of biometric characteristics of a body part, the device comprising:
a) a housing;
b) an acquisition chamber disposed in said housing;
c) an object plane extending approximately horizontally in said acquisition chamber;
d) a positioning assistance device which generates directions to assist in positioning of a surface of the body part to be imaged in said object plane; and
e) at least one camera which acquires a surface image of the body part from one direction, wherein said at least one camera comprises:
i) a lens system which provides substantially distortion-free imaging in an entire image field and has a depth of field corresponding to at least a maximum topographic extension of the surface of the body part to be imaged; and
ii) an image sensor.

2. The device according to claim 1, wherein said lens system has a depth of field corresponding to deviations in a position of the surface of the body part to be imaged from an ideal position.

3. The device according to claim 1, wherein a ratio of object width to focal length is greater than 10.

4. The device according to claim 1, further comprising at least one deviation mirror disposed in a beam path between said lens system and said object plane.

5. The device according to claim 1, further comprising at least one deviation prism disposed in a beam path between said lens system and said object plane.

6. The device according to claim 1, wherein the biometric characteristics of a body part are acquired from one side or from a plurality of sides.

7. The device according to claim 1, wherein said at least one camera acquires a plurality of images of the body part from a plurality of sides and wherein said plurality of images are evaluated individually or in combination.

8. The device according to claim 1, wherein said positioning assistance device comprises a light source which emits a light beam in a visible spectrum.

9. The device according to claim 8, wherein said light source is switched off during exposure.

10. The device according to claim 1, wherein said positioning assistance device comprises a sensor for determining an object plane of the body part and an output device which provides instructions to assist in positioning the body part in a desired object plane.

11. The device according to claim 10, wherein said sensor comprises a photoelectric barrier array.

12. The device according to claim 11, wherein said photoelectric barrier array emits light in an invisible spectrum.

13. The device according to claim 10, wherein said sensor comprises a distance sensor which operates on a capacitive, high-frequency or ultrasound basis.

14. The device according to claim 10, wherein said output device comprises an optical or acoustic display device.

15. The device according to claim 1, wherein said at least one camera acquires a plurality of shots of a surface image and wherein one or more of said plurality of shots having a desired quality are evaluated.

16. The device according to claim 1, wherein said at least one camera acquires a plurality of shots of a surface image at different exposures and wherein said plurality of shots of a surface image at different exposures are acquired and evaluated together.

17. The device according to claim 1, further comprising an illuminator device which illuminates a surface of the body part to be imaged.

18. The device according to claim 17, wherein said illuminator device comprises a light emitting diode arrangement.

19. The device according to claim 17, wherein said illuminator device comprises at least one flash tube.

20. The device according to claim 17, wherein an exposure can be controlled by regulating a duration of time during which said illuminator device lights.

21. The device according to claim 17, wherein said illuminator device emits white light or monochrome light of one or more wavelengths selected from a visible or invisible spectrum.

22. The device according to claim 21, wherein said illuminator device emits white light or monochrome light having a plurality of wavelengths and wherein a plurality of shots of a surface image are acquired.

23. The device according to claim 1, further comprising an evaluation device which determines a biometric characteristic mathematically by using a computation algorithm, wherein a same computation algorithm can be applied to different surface images of a body part and a different computation algorithms can be applied to a same surface images of a body part.

24. The device according to claim 23, wherein a computation algorithm which is applied during an initial acquisition of a surface image of a body part and which returns superior results is stored in a memory, and wherein said stored computation algorithm is applied preferentially during a subsequent acquisition of a same surface image of the body part.

25. The device according to claim 1, further comprising a light source and a sensor which determine a light transmitting capacity or a reflection characteristic of the body part to be imaged as an additional biometric characteristic.

26. The device according to claim 25, wherein said light source emits pulsed light or light of changing intensity and wherein said sensors are triggered by pulsed light or light of changing intensity and wherein said sensors generate signals which are evaluated.

27. The device according to claim 25, wherein said additional biometric characteristic is stored together with a biometric characteristic obtained by evaluating an acquired surface image of the body part.

28. The device according to claim 27, wherein a stored additional biometric characteristic is compared to a measured additional biometric characteristic to detect manipulation.

29. The device according to claim 27, wherein a measured biometric characteristic is compared to a stored biometric characteristic acquired on the basis of a surface image of the body part at a different light wavelength to detect manipulation.
